(19) United States
(12) Patent Application Publication
(10) Pub. No.: US 2025/0344624 A1
(43) Pub. Date: Nov. 13, 2025

(54) PTO COUPLING DEVICE FOR TRACTOR

(71) Applicant: Ki Hyuk PARK, Cholwon-gun (KR)

(72) Inventor: Ki Hyuk PARK, Cholwon-gun (KR)

(21) Appl. No.: 18/784,563

(22) Filed: Jul. 25, 2024

(30) Foreign Application Priority Data
May 7, 2024 (KR) 10-2024-0060008

(51) Int. Cl. A01B 71/06; A01D 69/00

(52) U.S. Cl. CPC A01B 71/063; A01D 69/002

(57) ABSTRACT

Provided is a power take off (PTO) coupling device for a tractor. The PTO coupling device includes: a first coupling part connected to a PTO shaft of the tractor; and a second coupling part detachably coupled to the first coupling part and connected to a power transmission shaft of a working machine. The first coupling part includes an accommodation part in a disc shape and having an accommodation space with openings formed in the accommodation part, and a PTO connection part on the front surface of the accommodation part to be fixed to the PTO shaft. The second coupling part includes one or more insertion members formed to be inserted into the openings and inserted into the accommodation space through the openings, and a power transmission connection part fixed to the rear surface of the insertion member and connected to the power transmission shaft of the working machine.

### BACKGROUND OF THE INVENTION

### Field of the Invention

The present invention relates to a power take off (PTO) coupling device for a tractor, and more particularly, to a PTO coupling device for a tractor designed to quickly connect coupling parts provided to transmit power from a PTO to a working machine at the rear of the tractor.

Additionally, the present invention relates to a PTO coupling device for a tractor, which includes a first coupling part directly connected and fixed to a PTO shaft and a second coupling part integrally fixed to a universal joint connected to a power transmission shaft of the working machine to transmit power from a PTO to a working machine at the rear of the tractor, thereby simplifying manufacturing, and significantly reducing manufacturing costs.

### Background Art

In general, a tractor is used to cultivate large areas of paddy fields or farm fields, primarily is operated in a state in which a working machine, such as a plow, a harrow, and a rotovator is attached to the rear of the tractor, to perform various agricultural operations like plowing, soil breaking, pest control, pumping, threshing, etc. The working machine connected to the tractor receives power generated from an engine of the tractor through a PTO to be operated.

Therefore, power is transmitted by mutually coupling a PTO shaft of the tractor and a power input shaft of the working machine. As an example of a coupling device, there is U.S. Pat. No. 11,313,417 (TRACTOR PTO QUICK-CONNECT DEVICE AND METHOD OF USE). As illustrated in FIG. 1 and FIG. 2, a receiver 207 having a connection hole 205 is provided at the central rear of a disc-shaped first plate 209 to allow a PTO shaft of the tractor to be interpolated and fixed by gear coupling. The first plate 209 has a plurality of openings 210a formed at regular intervals around the receiver 207, and small-sized openings 210b with a diameter smaller than the diameter of each opening 210a.

Connectors 213 to be inserted into the openings 210a are formed on the front surface of a disc-shaped second plate 211 are formed corresponding to the openings 210a. The connectors 213 have a cross-section formed in a ‘T’ shape.

That is, the connector 213 includes a cylindrical connector shaft 213b, and a disc-shaped connector top 213a which is larger in diameter than the connector shaft 213b and is formed at the top of the connector shaft 213b. The diameter of the connector top 213a is formed smaller than that of the opening 210a and larger than that of the small opening 210b.

Additionally, the second plate 211 has a shaft 223 formed at the central portion of the rear surface thereof to be connected with a power transmission shaft of a working machine, and gear teeth 402 are formed on the outer surface of the shaft 223 to be gear-coupled with a power coupling shaft of the working machine.

Therefore, the connectors 213 of the second plate 211 are respectively inserted into the openings 210a of the first plate 209, and are rotated in the direction of the small-sized openings 210b to prevent the connectors 213 from being separated from the openings 210a, and then, a locking shear pin 215 is inserted into through-holes 216 formed in both the first plate 209 and the second plate 211 to couple the the first plate 209 and the second plate 211, thereby fixing the first plate 209 and the second plate 211 together and transmitting power of the PTO to a power shaft of the working machine.

However, according to the conventional art, each of the plurality of connectors 213 needs to be individually fitted into the openings 210a and then a worker has to rotate the second plate 211 for coupling, but it is not easy to coincide and insert the plurality of connectors 213 into the openings 210a one by one.

That is, although it is said that the PTO can be quickly connected in the prior art, it is inconvenient to coincide and insert the plurality of connectors 213 into the openings 210a one by one while pulling and moving the second plate 211 towards the first plate 209, and it is not easy to couple the first plate 209 and the second plate 211 since the second plate 211 must be rotated in the direction of the small-sized opening 201b, resulting in reduced work efficiency.

Moreover, when the connector 213 is rotated in the direction of the opening 210a to separate the second plate 211 from the first plate 209, the connector top 213a gets caught on the outer part of the opening 210a while the connector shaft 213b gets in contact with the inner wall of the opening 210a, making it difficult to separate.

Accordingly, only when the connector top 213a aligns exactly with the opening 210a, the connector top 213a can be separated from the opening 210a such that the first plate 209 and the second plate 211 are separated. So, it is difficult to quickly separate the first plate 209 and the second plate 211.

Furthermore, to transmit power by inserting the connector 213 of the second plate 211 into the small-sized opening 210b through the opening 210a of the first plate 209, when large or sudden power is applied, the cylindrical connector shaft 213b is bent or broken.

Additionally, since the gear teeth 402 must be formed on the outer surface of the shaft 223 of the second plate 211 to connect to the universal joint of the power transmission shaft of the working machine, there is an issue of increased manufacturing costs due to the processing of the gear teeth 402, and reduced manufacturability.

### PATENT LITERATURE

### Patent Documents

Patent Document 1: U.S. Pat. No. 11, 313, 417 (TRACTOR PTO QUICK-CONNECT DEVICE AND METHOD OF USE)

### SUMMARY OF THE INVENTION

Accordingly, the present invention has been made to solve the above-mentioned problems occurring in the prior arts, and it is an objective of the present invention to provide a power take off (PTO) coupling device for a tractor, which couples a coupling part connected to a PTO and a coupling part connected to a power transmission shaft of a working machine through a simple storage method, thereby enabling quicker and more convenient coupling.

It is another objective of the present invention to provide a power take off (PTO) coupling device for a tractor, which has a structure of inserting, rotating and fixing the coupling parts to transmit power of the PTO to the working machine at the rear of the tractor, thereby enabling quick connection and quick and easy separation.

It is a further objective of the present invention to provide a power take off (PTO) coupling device for a tractor, which includes a first coupling part directly connected and fixed to a PTO shaft and a second coupling part integrally fixed to a universal joint connected to a power transmission shaft of the working machine.

To accomplish the above object, according to the present invention, there is provided a power take off (PTO) coupling device for a tractor including: a first coupling part connected to a PTO shaft of the tractor; and a second coupling part detachably coupled to the first coupling part and connected to a power transmission shaft of a working machine to provide power transferred from the first coupling part to the working machine, wherein the first coupling includes an part accommodation part formed in the form of a housing with an open top and having an accommodation space formed therein, and a PTO connection part fixed to the rear surface of the accommodation part and coupled to the PTO shaft of the tractor, and wherein the second coupling part includes an insertion member having the size and shape to be accommodated in the accommodation part, and a power transmission connection part fixed to the rear surface of the insertion member and connected to the power transmission shaft of the working machine.

Furthermore, in another aspect of the present invention, there is provided a power take off (PTO) coupling device for a tractor, including: a first coupling part connected to a PTO shaft of the tractor; and a second coupling part detachably coupled to the first coupling part and connected to a power transmission shaft of a working machine to provide power transferred from the first coupling part to the working machine, wherein the first coupling part includes an accommodation part formed in a disc shape and having an accommodation space formed therein, one or more openings formed in the front surface of the accommodation part to communicate with the accommodation space, and a PTO connection part formed on the front surface of the accommodation part to be fixed to the PTO shaft of the tractor, wherein the second coupling part includes one or more insertion members formed to be inserted into the openings and inserted into the accommodation space through the openings, and a power transmission connection part fixed to the rear surface of the insertion member and connected to the power transmission shaft of the working machine, and wherein the accommodation space allows the insertion members inserted through the openings to be accommodated by rotating laterally, and includes a rotation prevention stopper which is in contact with the sides of the insertion members to transmit power and restrict rotation.

In a further aspect of the present invention, there is provided a power take off (PTO) coupling device for a tractor including: a first coupling part, of which a rear portion is integrally formed on a PTO connection part for coupling with a PTO shaft to receive power; and a second coupling part which is detachably coupled to the first coupling part to receive power, and on the rear surface of which a universal joint having a shaft connection part to be connected to a power transmission shaft of a working machine is integrally fixed.

As described above, according to an embodiment of the present invention, the PTO coupling device for a tractor can simply insert and couple the second coupling part fixed to the power transmission shaft of the working machine to the first coupling part with the housing shape fixed to the PTO shaft of the tractor or can directly separate the second coupling part from the first coupling part, thereby facilitating the connection work of the working machine to provide excellent work efficiency.

Additionally, the PTO coupling device for a tractor can guide and insert the second coupling part along the tapered inclined surface of the first coupling part, thereby facilitating the coupling operation between the first coupling part and the second coupling part even if the worker does not fit the first coupling part and the second coupling part precisely.

Furthermore, according embodiment of the present invention, the PTO coupling device for a tractor can quickly couple the first coupling part and the second coupling part and quickly separate the second coupling part from the first coupling part by inserting, rotating and fixing the second coupling part fixed to the power transmission shaft of the working machine to the first coupling part fixed to the PTO shaft of the tractor. Moreover, the PTO coupling device for a tractor can transmit power since the second coupling part is in contact with the first coupling part over a large area, thereby preventing damage caused by large or sudden power.

In addition, according to yet another embodiment of the present invention, the PTO coupling device for a tractor can eliminates the need for gear teeth at least at the connection area between the second coupling part and the universal joint by by directly connecting the first coupling part to the PTO shaft of the tractor and fixing them with a pin and directly connecting and fixing the second coupling part to the universal joint provided on the power transmission shaft of the working machine, thereby reducing manufacturing costs and increasing productivity.

### BRIEF DESCRIPTION OF THE DRAWINGS

FIGS. 1 and 2 are views illustrating a structure of a PTO coupling device according to a conventional art.

FIG. 3 is a view illustrating a structure of a PTO coupling device according to an embodiment of the present invention.

FIG. 4 is a sectional view of the coupling in FIG. 3.

FIG. 5 is a view illustrating a detailed structure of a first coupling part and a second coupling part.

FIG. 6 is a view illustrating coupling of FIG. 5.

FIG. 7 is a sectional view illustrating coupling of FIG. 6.

FIG. 8 is a view illustrating another form of the first coupling part.

FIG. 9 is a view illustrating a first coupling part and a second coupling part according to another embodiment of the the present invention.

FIG. 10 is a view illustrating the coupled state of FIG. 9.

FIG. 11 is a view illustrating an internal structure of the first coupling part of FIG. 9.

FIG. 12 is a sectional view of the coupling between the first coupling part and the second coupling part in FIG. 9.

FIGS. 13 and 14 are views illustrating a first coupling part and a second coupling part according to a further embodiment of the present invention.

FIG. 15 is a view illustrating a structure of a PTO coupling device of a tractor to which the first coupling part and the second coupling part according to another embodiment are applied.

FIG. 16 is a sectional view of the coupling between the first coupling part and the second coupling part in FIG. 15.

FIG. 17 is a view illustrating a structure of a PTO coupling device according to a further embodiment of the present invention.

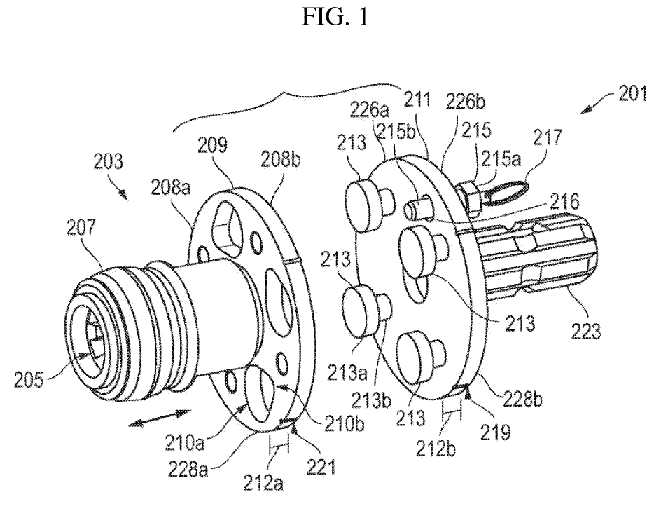

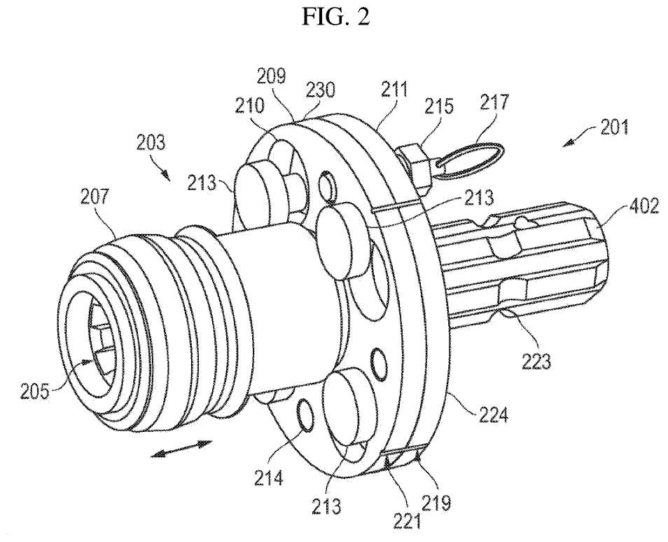

### DETAILED DESCRIPTION OF THE PREFERRED EMBODIMENT

The foregoing objectives, features, and advantages will be described in detail with reference to the accompanying drawings. Accordingly, it would be understood that those skilled in the relevant technical field can easily realize the technical ideas of the present invention. In the description of the present invention, when it is judged that detailed descriptions of known functions or structures related with the present invention may make the essential points vague, the detailed descriptions of the known functions or structures will be omitted. The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Hereinafter, embodiments of the present invention will be described in detail with reference to the accompanying drawings.

However, the embodiments of the present invention exemplified below can be modified in various different forms, and the scope of the present invention is not limited to the embodiments described below.

The embodiments of the present invention are provided to more completely describe the present invention to those skilled in the art.

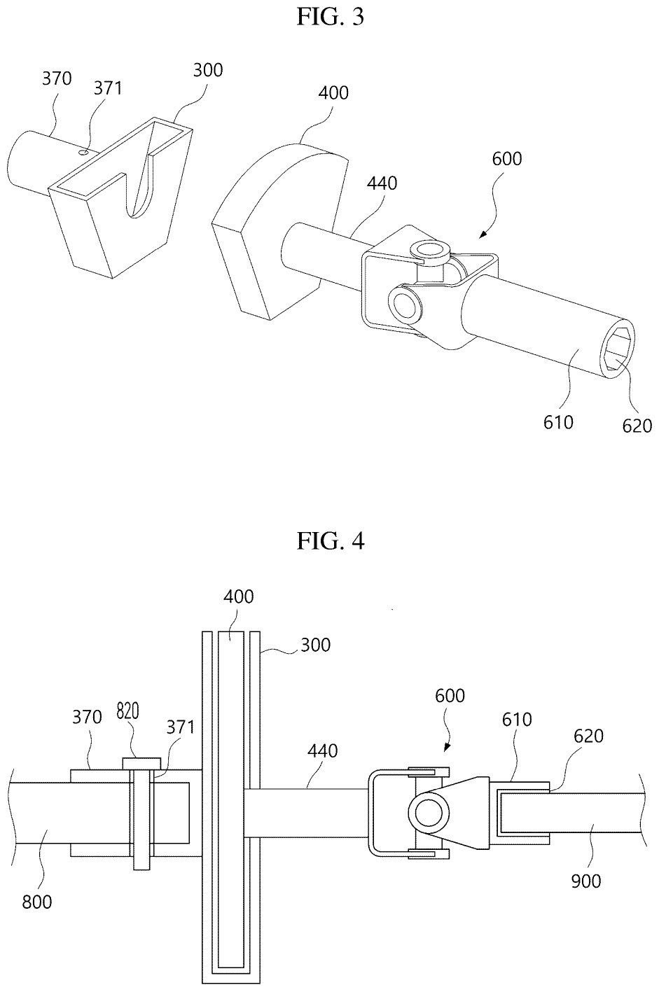

FIG. 3 is a view illustrating a structure of a PTO coupling device according to an embodiment of the present invention. The PTO coupling device according to an embodiment of the present invention includes: a first coupling part 300 of which a rear portion is integrally formed on a PTO connection part 370 for coupling with a PTO shaft 800 to receive power; and a second coupling part 400 which is detachably coupled to the first coupling part 300 to receive power, and on the rear surface of which a universal joint 600 having a shaft connection part 610 to be connected to a power transmission shaft 900 of a working machine is integrally fixed.

The first coupling part 300 can be quickly coupled to the second coupling part 400 by a fit-in structure, and the PTO connection part 370 is integrally formed on the rear surface of the first coupling part by welding. The PTO connection part 370 is formed in a tubular shape, and a PTO shaft 800 is inserted into the PTO connection part 370.

In this instance, the coupling structure may be a structure fixed or fastened by a spring pin or a bolt, or other various types of coupling structures.

One side of the universal joint 600, which is connected to the power transmission shaft 900 of the working machine is integrally fixed to the rear surface of the second coupling part 400 through a power transmission connection part 440, and the power transmission shaft 900 of the working machine is inserted into the other side of the universal joint 600 such that a shaft connection part 610 which engages by gear teeth 630 is provided integrally.

In this instance, the power transmission connection part 440 may be formed as a single body with the second coupling part 400 or may be integrally formed through various fastening methods such as welding, pins, bolts, etc.

Additionally, the power transmission connection part 440 may have gear teeth formed on the outside depending on the shape of the power transmission shaft 900.

As illustrated in FIG. 4, the PTO shaft 800 is inserted into the PTO connection part 370 of the first coupling part 300, and is fixed and coupled by a pin or a bolt inserted into a pin hole 371. The power transmission shaft 900 of the working machine is inserted and geared into the shaft connection part 610 of the second coupling part 400. Accordingly, when the second coupling part 400 is coupled to the first coupling part 300, power of the tractor is transmitted to the working machine.

Due to such a structure, a power transmission structure can be quickly detachably attached to the PTO by the first coupling part 300 and the second coupling part 400, and the gear teeth which are partially eliminated facilitates manufacturing and reduces manufacturing costs.

That is, in the present invention, the gear teeth 620 are formed only on the shaft connection part 610 of the universal joint 600, but in the conventional structure, the gear teeth 205 are formed on the first plate 209, on the outer surface of the shaft 223 of the second plate 211, and on the universal joint coupled with the shaft 223. So, the conventional art requires processing work for three gear teeth.

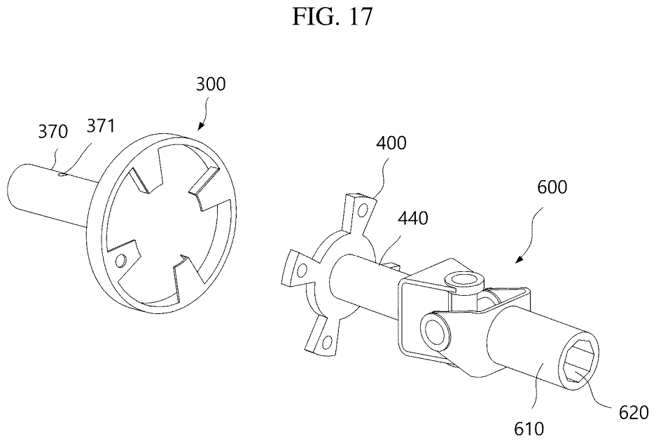

Here, it is understood that the first coupling part 300 and the second coupling part 400 can be substituted with the first coupling part 300 and the second coupling part 400 illustrated in FIG. 17.

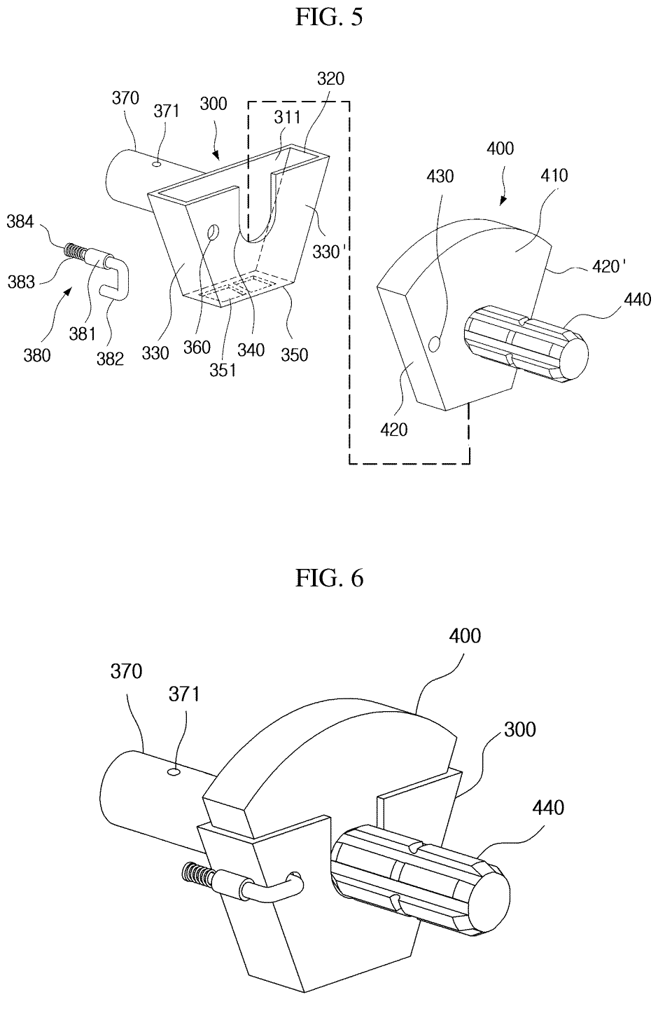

FIGS. 5 through 8 illustrate the first coupling part 300 and the second coupling part 400 according to an embodiment of the present invention. The first coupling part 300 includes an accommodation part 310 in the form of a housing, and the PTO connection part 370 to be connected to the PTO shaft of the tractor is fixed to the rear surface of the accommodation part 310. The PTO shaft of the tractor is inserted into the PTO connection part 370, and then, a coupling pin is inserted and fastened into the pin hole 371, such that the PTO shaft and the PTO connection part 370 are coupled to transmit power.

Of course, to fix the PTO shaft and the PTO connection part 370, not only the pin but also a bolt-coupling method can be applied, and other various types of pin fastening methods or bolt fastening methods can be applied.

Moreover, it is preferable to locate the PTO connection part 370 at the central portion of the rear surface of the accommodation part 310, but the PTO connection part 370 can be located anywhere without affecting functionality.

The accommodation part 310 of a housing shape includes an interior accommodation space 311 and an upper opening 320 formed at the top. For this, the accommodation part 310 includes: a rear panel where the PTO connection part 370 is fixed; a front panel spaced forward from the rear panel by the extent of the accommodation space 311; side walls forming side surfaces between the rear and front panels; and a bottom panel.

The second coupling part 400 has a shape and a size to fit accurately into the accommodation space 311 of the first coupling part 300, and includes an insertion member 410, which has a size and a shape corresponding to the width and length of the accommodation space 311, and a thickness equal to an interval space between the rear and front panels of the accommodation space 311.

In addition, a power transmission connection part 440 is fixed at the rear part of the insertion member 410 for connection to the power transmission shaft of the implement via a universal joint. The power transmission connection part 440 has gear teeth formed around the outer perimeter thereof to be inserted into and engage with one side of the universal joint. It is preferable, though not necessary, for the power transmission connection part 440 to align linearly with the PTO connection part 370 when the insertion member 410 is inserted and coupled into the accommodation part 310.

That is, since the universal joint is equipped on the power transmission shaft of the working machine, power transmission can be achieved even though the PTO connection part 370 and the power transmission connection part 440 are not aligned linearly.

Therefore, when the insertion member 410 of the second coupling part 400 is lifted upwards and then inserted downward through the upper opening 320 of the accommodation part 310 to be fit, the insertion member 410 naturally descends into the accommodation part 310 by self-weight of the insertion member 410 and is stored inside the accommodation part 310 to be fit accurately, and then, the accommodation part 310 and the insertion member 410 are locked by a locking pin 380.

Pin fixation holes 360 and 430 are perforated and formed at corresponding positions of the accommodation part 310 and the insertion member 410. As illustrated in FIG. 6, when the insertion member 410 is stored in the accommodation part 310, the locking pin 380 is inserted into the pin fixation holes 360 and 430 to secure the assembly.

Furthermore, the locking pin 380 can be provided separately, and may have a structure fixed to the accommodation part 310 as illustrated in FIGS. 5 and 6.

For this purpose, the locking pin 380 includes: a straight pipe-shaped fixing part 381 that is welded or similarly attached to the outside of one side wall of the accommodation part 310; a pin 382 inserted through the fixing part 381; a stopper 384 provided at one side of the pin 382; and a spring 383 fitted around the pin 382 between the stopper 384 and the fixing part 381 to elastically support the pin 382. The opposite end of the pin 382 is bent in the direction of the pin fixation holes 360 and 430.

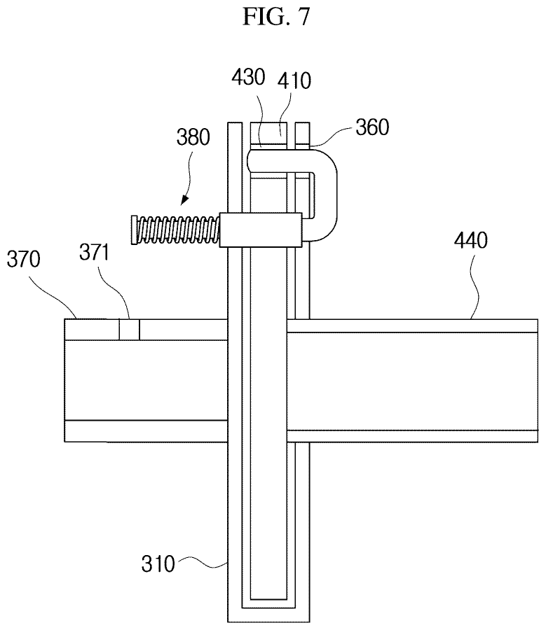

Therefore, by inserting the insertion member 410 into the accommodation part 310, the pin fixation holes 360 and 430 are aligned. Thereafter, when the bent portion is rotated in the direction of the pin fixation holes 360 and 430 to be inserted into the pin fixation holes 360 and 420 by pulling the opposite end of the pin 382, as illustrated in FIG. 7, the bent portion of the pin 382 can maintain the inserted state into the pin fixation holes 360 and 430 due to elastically supporting force of the spring 383 to fix the accommodation part 310 and the insertion member 410, thereby preventing separation during rotation induced by driving power and achieving the coupling of the accommodation part 310 and the insertion member 410 very simply.

Therefore, the accommodation part 310 is rotated by the rotation of the PTO shaft, and the rotational force is transmitted to the insertion member 410, and then, is transmitted to the power transmission shaft of the working machine through the power transmission connection part 440.

To separate the insertion member 410 from the accommodation part 310, a worker pulls the pin 382 and rotates the pin in the lateral direction of the accommodation part 310, and then, lifts the insertion member 410. Then, the insertion member 410 can be separated from the accommodation part 310 very easily.

Meanwhile, to facilitate the insertion of the insertion member 410 into the accommodation part 310, it is preferable that the sidewalls of the accommodation space 311 have inclined portions 330 and 330′ which are tapered to be gradually narrower in the downward direction, and the insertion member 410 also has inclined portions 420 and 420′ which are tapered downward to correspond to the inclined portions 33 and 330′ of the accommodation space 311.

Therefore, as the narrower bottom part of the insertion member 410 is inserted upwardly through the wider upper opening 320 of the accommodation part 310, the insertion member 410 is guided by the tapered portions 330 and 330′ of the accommodation part 310 to ensure accurate coupling.

At this time, a front opening 340, which is partially open up to the top, i.e., the upper opening 320, is formed on the front part of the accommodation part 310. It is preferable for the power transmission connection part 440 to be inserted through the front opening 340 when the insertion member 410 is being inserted.

The accommodation part 310 has a lower opening 351 formed in a portion of a bottom part 350 to allow foreign materials such as dirt, water, straw, and grass entering the accommodation space 311 to be expelled to the outside. The bottom part 350 may be designed in a stopper type to disperse weight applied to the inclined portions 330 and 330′ when the insertion member 410 is inserted into the accommodation part 310, thereby preventing damage to the accommodation part 310 and ensuring accurate alignment of the pin fixation holes 360 and 430.

Additionally, it is preferable for the tapered sections 330 and 330′ and 420 and 420′ to be respectively formed on both sides of the accommodation part 310 and the insertion member 410, but it is also acceptable for them to be formed on any one side.

That is, any shape that the lower portion of the insertion member 410 is narrower than the open upper portion of the accommodation space 311 is permissible.

For example, the accommodation part 310 and the insertion member 410 can take various shapes, such as

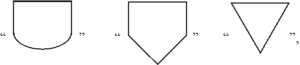

etc.

Although it has been illustrated and described that the accommodation part 310 has a plate-like form with the accommodation space 311 therein, the accommodation part 310 may have not only the plate form but also various three-dimensional forms, such as an open-top hemispherical shape or an open-top pyramidal shape.

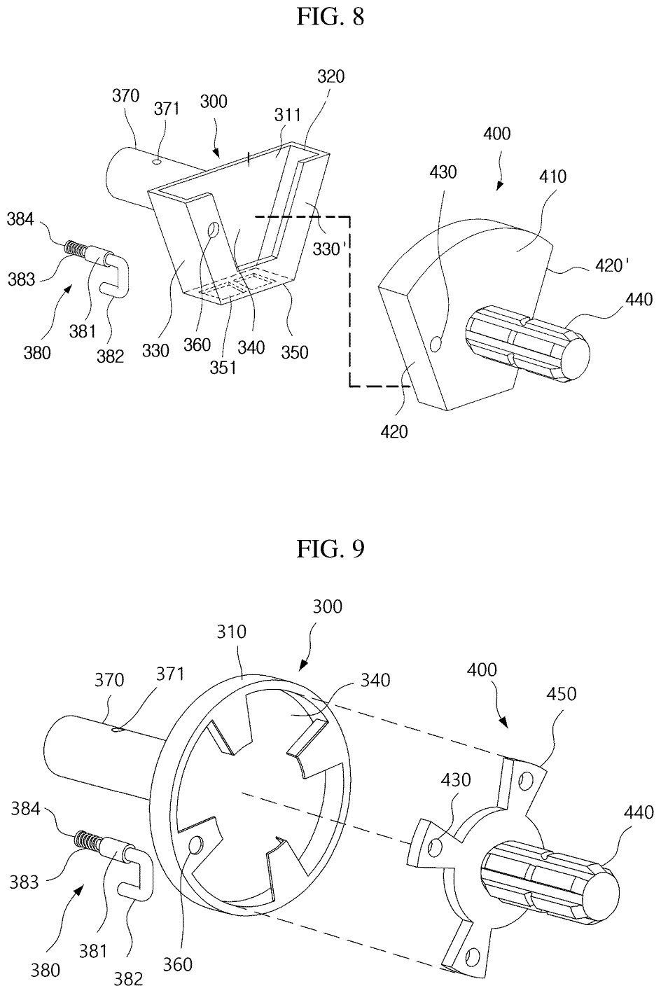

FIG. 8 illustrates another form of the accommodation part 310, wherein separation prevention jaws 341 are formed to extend inwardly from the front portions of the side surfaces of the accommodation part 310, so the front opening 340 is formed between the separation prevention jaws 341.

Of course, the separation prevention jaws 341 may further have a structure extending inward from the front portion of the bottom as occasion demands. It is preferable that separation prevention jaws 341 are formed such that both edges or both edges and the bottom edge can be caught when the insertion member 410 is inserted into the accommodation part 310.

Thus, the lower portion of the insertion member 410 can be inserted into the accommodation space 311 through the front opening 340 just by slightly lifting the insertion member 410 even though the insertion member 410 is not lifted till the lower portion of the insertion member 410 is located above the upper side of the accommodation part 310.

In a case in which a structure is located above the PTO shaft of the tractor, when the insertion member 410 is lifted above the accommodation part 310, the insertion member 410 cannot be inserted into the space part 310 due to interference between the structure and the insertion member 410. However, due to the form of the accommodation part 310 of the present invention, the insertion member 410 can be coupled with the accommodation part 310 while avoiding the interference with a structure.

Moreover, the pin fixation holes 360 may be formed in the separation prevention jaws 341 to allow the accommodation part 310 and the insertion member 410 to be secured together.

FIGS. 9 through 12 illustrate the first coupling part 300 and the second coupling part 400 according to another embodiment. The first coupling part 300 includes a disc-shaped accommodation part 310 having an accommodation space 311 therein. The accommodation part 310 includes a disc-shaped rear panel, a disc-shaped front panel spaced apart from the rear panel and located at a front portion thereof, and side panels located along the outer peripheries of the rear panel and the front panel to fix the rear panel and the front panel. The accommodation space 311 is formed between the rear panel and the front panel inside the accommodation part 310.

At the rear part of the accommodation part 310, a PTO connection part 370 is fixed for coupling with the PTO shaft of the tractor. The PTO shaft of the tractor is inserted into the PTO connection part 370, and then, a coupling pin is inserted and fastened into the pin hole 371, such that the PTO shaft and the PTO connection part 370 are coupled to transmit power.

Of course, to fix the PTO shaft and the PTO connection part 370, not only the pin but also a bolt-coupling method can be applied, and other various types of pin fastening methods or bolt fastening methods can be applied.

Additionally, a plurality of openings 340 are formed in the front portion of the accommodation part 310, namely the front panel, at regular intervals. The openings 340 has a shape widening outward from the middle portion of the front area, and the plurality of openings 340 communicate with each other at the central portion of the accommodation part 310.

Moreover, within the accommodation space 311, as illustrated in FIG. 11, a rotation prevention stopper 312 is preferably formed in the lateral direction of the opening 340, namely, in the opposite direction to the rotational direction of the accommodation part 310. Preferably, the rotation prevention stopper 312 is positioned close to or between neighboring openings.

In other words, the rotation prevention stopper 312, which restricts the rotation of the insertion member 450 of the second coupling part 400 at the same position while still enabling power transmission via surface contact, is formed inside the accommodation space 11 between the openings.

The most preferably, the openings 340 and the accommodation space between the openings have the same size and shape as the insertion member 450. Furthermore, the rotation prevention stopper 312 is formed on the side of each neighboring openings, namely, on one side facing the rotational direction of the accommodation part 310, such that the accommodation space 311 communicates with the opposite side of the opening 340 and the insertion member 450 inserted into the opening 340 is rotated to be inserted into the accommodation space 311 between the openings.

The rotation prevention stopper 312 has the same shape as the side of the insertion member 450, thereby maximizing a contact surface.

The second coupling part 400 has a plurality of insertion members 450 that can be inserted into the accommodation space 311 through the openings 340 of the first coupling part 300.

That is, the second coupling part 400 has the plurality of insertion members 450 with a blade shape formed radially at intervals to be respectively inserted into the plurality of openings 340. The power transmission connection part 440 is fixed at the rear portion of the insertion member 450 to be connected with the power transmission shaft of the working machine through the universal joint. The power transmission connection part 440 has gear teeth to be inserted and geared into one side of the universal joint along the outer circumference thereof. Preferably, the power transmission connection part 440 is aligned with the PTO connection part 370 in a straight line when the insertion member 410 is inserted and coupled into the accommodation part 310, but there is no problem even though the power transmission connection part 440 is not aligned with the PTO connection part 370 in a straight line.

That is, since the universal joint is provided on the power transmission shaft of the working machine, even though the power transmission connection part 440 is not aligned with the PTO connection part 370 in a straight line, power transmission can be achieved.

Therefore, when the insertion member 450 of the second coupling part 400 is inserted through the opening 340 of the accommodation part 310 and the accommodation part 310 is rotated in the opposite direction to the rotational direction, the insertion member 450 is rotated and moved into the accommodation space 311 between the openings, and the side in the rotational direction is in face-to-face contact with the rotation prevention stopper 312 to prevent rotation.

The rotation prevention stopper 312 may be formed at a position where the entire insertion member 450 is inserted into the accommodation space 311 between the openings or at a position where only a portion of the insertion member 450 is inserted into the accommodation space 311.

Furthermore, the width of the insertion member 450 is made smaller than the width of the openings 340 so that the insertion member 450 can be easily inserted into the opening 340, and preferably, the length of the insertion member 450 is slightly shorter than that of the openings 340.

At the position where the insertion member 450 is inserted into the accommodation part 310 and the side of the insertion member 450 is in contact with the rotation prevention stopper 312, the accommodation part 310 and the insertion member 450 are locked by a locking pin 380 which is a locking means.

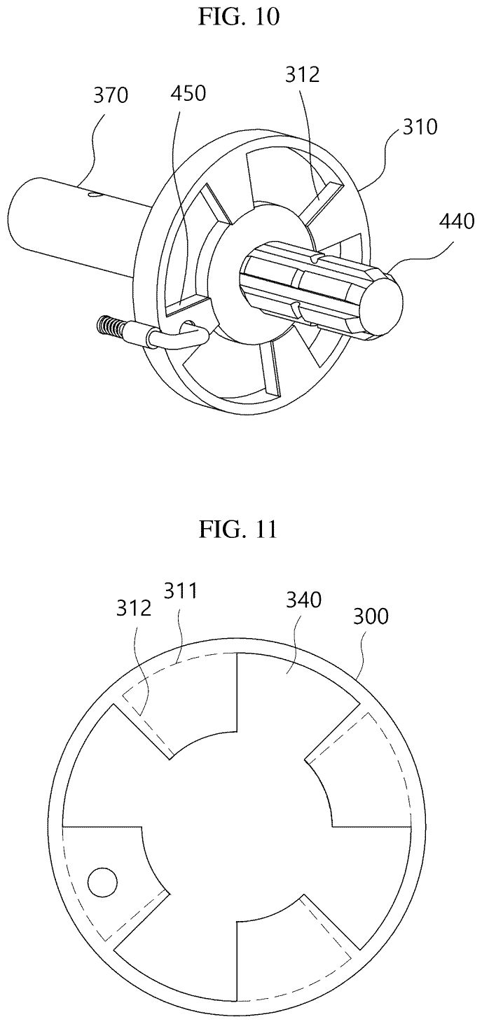

For this purpose, pin fixation holes 360 and 430, which is the locking means, are formed at corresponding positions of the accommodation part 310 and the insertion member 450, and as illustrated in FIG. 10, when the insertion member 410 is inserted into the accommodation part 310, the locking pin 380 can be inserted into the pin fixation holes 360 and 430 to achieve the coupling.

In this instance, preferably, the pin fixation hole 430 is formed in the insertion member 450.

The locking pin 380 may also be separately provided, or may have a structure fixed to the accommodation part 310 as illustrated in FIG. 9.

The locking pin 380 includes: a straight pipe-shaped fixing part 381 which is fixed to the outside of one side wall of the accommodation part 310 by welding or others; a pin 382 inserted through the fixing part 381; a stopper 384 provided on one side of the pin 382; and a spring 383 fit between the stopper 384 and the fixing part 381 outside the pin 382 to elastically support the pin 382. The opposite side of the pin 382 is bent in the direction of the pin fixation holes 360 and 430.

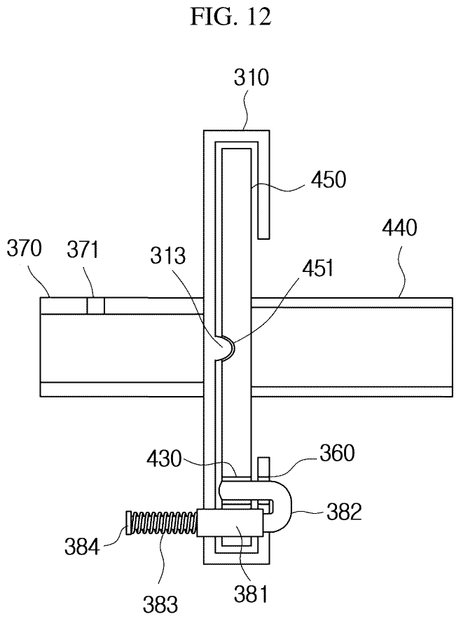

After the insertion member 450 is inserted into the accommodation part 310, the insertion member 450 is rotated into the accommodation space 311 as illustrated in FIG. 10, and the pin fixation holes 360 and 430 are aligned. Subsequently, when pulling and rotating the bent portion of the pin 382 toward the pin fixation holes 360 and 430 for insertion, the bent portion of the pin 382 is maintained in the pin fixation holes 360 and 430 by the elastic support of the spring 383 as illustrated in FIG. 12, to fix the accommodation part 310 and the insertion member 450, thereby preventing separation during rotation by driving power, and achieving the coupling between the accommodation part 310 and the insertion member 450.

Accordingly, due to the rotation of the PTO shaft, the accommodation part 310 is rotated, and the rotational force is transmitted to the insertion member 450, and then, is transmitted to the power transmission shaft of the working machine through the power transmission connection part 440.

To separate the insertion member 450 from the accommodation part 310, the worker pulls the pin 382 and rotates the pin in the lateral direction of the accommodation part 310, and then, rotate the insertion member 450 in the rotational direction to locate in the opening 340, thereby facilitating separation.

Meanwhile, although it has been described that the plurality of openings 340 are formed in the accommodation part 310 and the plurality of insertion members 450 are formed corresponding to the plurality of openings, but as another form, one or more openings 340 may be formed, and one or more insertion members 450 may be formed corresponding to the one or more openings 340.

Furthermore, preferably, a centering member is provided to fix the central portion of the insertion member 450 at the central portion of the accommodation part 310 when the insertion member 450 is inserted into the opening 340, thereby allowing for smooth rotation by preventing the outer edge from being in contact with the inner surface of the accommodation part 310 when the insertion member 450 rotates towards the accommodation space 311. A centering protrusion 313 is formed at the center of the rear panel of the accommodation part 310, and a centering groove 451 is formed at the center of the insertion member 450 such that the protrusion 313 and the groove 451 are coupled with each other to be centered. Accordingly, the edges of the insertion member 450 do not interfere with the inner surface of the accommodation part 310 and can be rotated toward the accommodation space 311.

Of course, the centering groove may be formed at the central portion of the rear panel of the accommodation part 310, and the centering protrusion may be formed at the central portion of the insertion member 450.

FIG. 13 illustrates a further embodiment of the present invention. The first coupling part 300 includes a disc-shaped first body 390, the PTO connection part 370 to be coupled to the PTO shaft of the tractor is fixed to the rear portion of the first body 390, and one or more retaining grooves 391 are formed on the periphery of the first body 390.

Similarly, the second coupling part 400 also includes a disc-shaped second body 460, and one or more retaining hooks 461 are protrudingly formed on a portion facing the first body 390 in the peripheral direction according to the position and the number of corresponding to the retaining grooves 391.

The retaining hook 461 includes: a protrusion portion 461-1 protruding forward; and a ‘ [symbol] ’-shaped bent portion 461-2 bent at a front end portion of the protrusion portion 461-1 in one direction. Additionally, preferably, the retaining groove 391 has a curved shape in the rotational direction when the retaining hook 461 is inserted and rotated.

Moreover, as illustrated in FIGS. 9 and 10, the first body 390 and the second body 460 respectively include pin fixing holes, and a locking pin is provided to be inserted into the pin fixing holes. As illustrated in FIG. 12, preferably, coupling members are provided at the central portion of the first body 390 and the central portion of the second body 460.

Therefore, when the retaining hook 461 is inserted into the retaining groove 391, the bent portion 461-2 passes through the retaining groove 391 and protrudes to the rear of the first body 390, and then, the first coupling part 300 is rotated in the rotational direction for power transmission or the second coupling part 400 is rotated in the opposite direction. Then, the retaining groove 391 and the retaining hook 461 are caught and coupled to each other, thereby achieving power transmission.

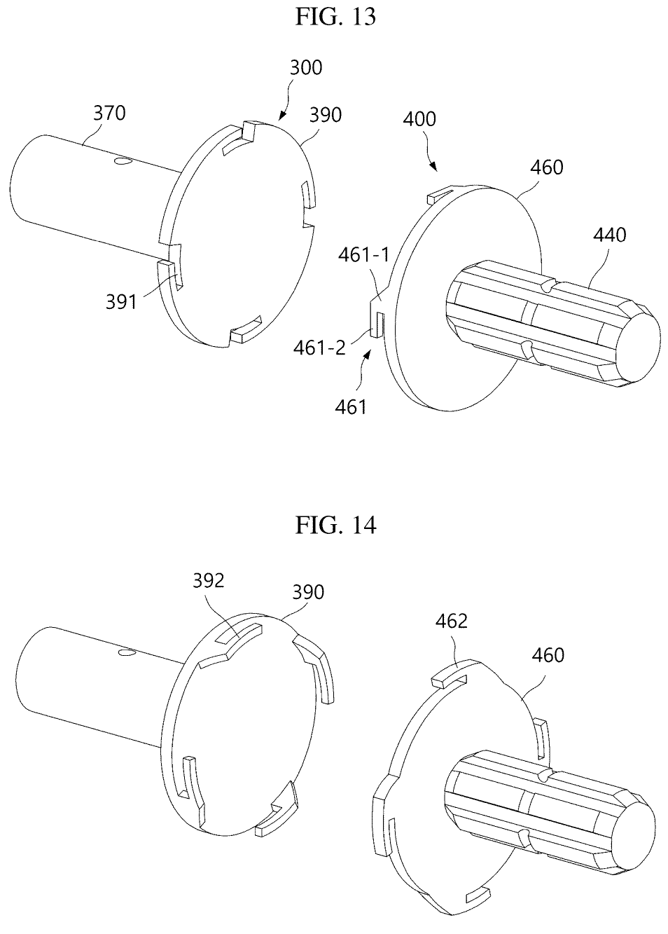

FIG. 14 illustrates a further embodiment of the present invention. The first coupling part 300 includes a disc-shaped first body 390, the PTO connection part 370 to be coupled to the PTO shaft of the tractor is fixed to the rear portion of the first body 390, and one or more retaining hooks 392 protrude forwards on the front portion, namely, the portion facing the second coupling part 400 in an ‘L’ shape along the the periphery thereof.

Moreover, in the same way, the second coupling part 400 also includes a disc-shaped second body 460, and one or more retaining latches 461 are protrudingly formed outwards along the outer periphery thereof in a ‘ [symbol] ’-shape according to the position and the number of corresponding to the retaining hooks 392 of the first body 390.

Therefore, the first coupling part 300 is rotated in the rotational direction for power transmission or the second coupling part 400 is rotated in the opposition direction, such that the retaining hook 392 and the retaining latch 462 are caught and coupled to each other, thereby achieving power transmission.

In the same way, the first body 390 and the second body 460 respectively include pin fixing holes, and a locking pin is provided to be inserted into the pin fixing holes. Moreover, coupling members are provided at the central portion of the first body 390 and the central portion of the second body 460.

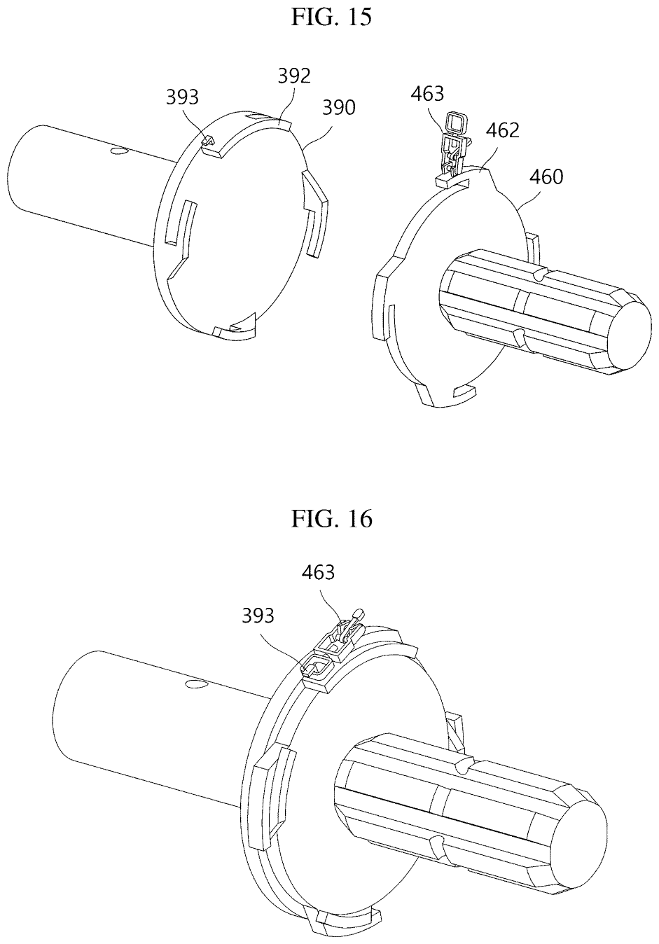

Alternatively, locking means having a catch structure may be provided instead of the pin fixing holes 360 and 430 and the locking pins 380. For instance, as illustrated in FIGS. 15 and 16, a catch hook 393 may be formed on the retaining hook 392 of the first body 390, and a rotatable catch part 463 may be provided on the retaining latch 462 of the second body 460, thus locking the first body 390 and the second body 460 together.

Of course, the catch part may be formed on the first body 390 and the catch hook may be formed on the second body 460, and such catch structures could be applied in other embodiments of the present invention.

That is, one of the coupling parts has a catch part provided as a locking means, and the other coupling part has a catch hook to achieve locking when the catch part and the catch hook are coupled to each other.

As described above, specific parts of the present invention have been described in detail. It should be understood that the specific description is merely a preferred embodiment and does not limit the scope of the present invention.

Therefore, the actual scope of the present invention is defined by the attached claims and the equivalents.

What is claimed is:

1. A power take off (PTO) coupling device for a tractor, comprising:
a first coupling part connected to a PTO shaft of the tractor; and
a second coupling part detachably coupled to the first coupling part and connected to a power transmission shaft of a working machine to provide power transferred from the first coupling part to the working machine,
wherein the first coupling part comprises:
an accommodation part formed in the form of a housing with an open top and having an accommodation space formed therein; and
a PTO connection part fixed to the rear surface of the accommodation part and coupled to the PTO shaft of the tractor, and
wherein the second coupling part comprises:
an insertion member having the size and shape to be accommodated in the accommodation part; and
a power transmission connection part fixed to the rear surface of the insertion member and connected to the power transmission shaft of the working machine.

2. The PTO coupling device according to claim 1, wherein the accommodation space of the first coupling part is formed such that both side walls or one side wall get narrower downwards in the width, and the insertion member of the second coupling part is formed such that both side walls or one side wall are inclined to correspond to the accommodation space.

3. A power take off (PTO) coupling device for a tractor, comprising:
a first coupling part connected to a PTO shaft of the tractor; and
a second coupling part detachably coupled to the first coupling part and connected to a power transmission shaft of a working machine to provide power transferred from the first coupling part to the working machine,
wherein the first coupling part comprises:
an accommodation part formed in a disc shape and having an accommodation space formed therein;
one or more openings formed in the front surface of the accommodation part to communicate with the accommodation space; and
a PTO connection part formed on the front surface of the accommodation part to be fixed to the PTO shaft of the tractor,
wherein the second coupling part comprises:
one or more insertion members formed to be inserted into the openings and inserted into the accommodation space through the openings; and
a power transmission connection part fixed to the rear surface of the insertion member and connected to the power transmission shaft of the working machine, and
wherein the accommodation space allows the insertion members inserted through the openings to be accommodated by rotating laterally, and includes a rotation prevention stopper which is in contact with the sides of the insertion members to transmit power and restrict rotation.

4. The PTO coupling device according to claim 3, wherein the openings are radially formed at regular intervals and communicate with the accommodation space, the insertion members are radially formed at intervals to be inserted into each of the plurality of openings, and the rotation prevention stopper is provided between the opening of the accommodation space and the adjacent opening.

5. The PTO coupling device according to claim 3, wherein the accommodation part and the insertion member respectively have pin fixing holes formed at corresponding positions, and a locking pin is inserted into the pin fixing holes to prevent the insertion member from detaching from the accommodation part.

6. The PTO coupling device according to claim 3, wherein centering members are respectively provided at the central portion of the insertion member and at the central portion of the accommodation part for mutual centering.

7. A power take off (PTO) coupling device for a tractor, comprising:
a first coupling part connected to a PTO shaft of the tractor; and
a second coupling part detachably coupled to the first coupling part and connected to a power transmission shaft of a working machine to provide power transferred from the first coupling part to the working machine,
wherein the first coupling part comprises:
a disc-shaped first body;
a PTO connection part fixed to the rear surface of the first body to be coupled to the PTO shaft of the tractor; and
one or more retaining grooves formed around the periphery thereof, and
wherein the second coupling part comprises:
a disc-shaped second body; and
one or more retaining hooks protrudingly formed on a portion facing the first body in the peripheral direction according to the position and the number of corresponding to the retaining grooves to be inserted into the retaining grooves.

8. A power take off (PTO) coupling device for a tractor, comprising:
a first coupling part connected to a PTO shaft of the tractor; and
a second coupling part detachably coupled to the first coupling part and connected to a power transmission shaft of a working machine to provide power transferred from the first coupling part to the working machine,
wherein the first coupling part comprises:
a disc-shaped first body;
a PTO connection part fixed to the rear surface of the first body to be coupled to the PTO shaft of the tractor; and
one or more retaining hooks protrudingly formed on the front surface thereof along the periphery thereof, and
wherein the second coupling part comprises:
a disc-shaped second body; and
one or more retaining latches protrudingly formed outwards along the outer periphery thereof according to the position and the number of corresponding to the retaining hooks of the first body.

9. A power take off (PTO) coupling device for a tractor comprising:
a first coupling part, of which a rear portion is integrally formed on a PTO connection part for coupling with a PTO shaft to receive power; and
a second coupling part which is detachably coupled to the first coupling part to receive power, and on the rear surface of which a universal joint having a shaft connection part to be connected to a power transmission shaft of a working machine is integrally fixed.

10. The PTO coupling device according to claim 1, wherein the first coupling part is configured in such a way that a rear portion of the first coupling part is integrally formed on a PTO connection part for coupling with a PTO shaft to receive power, and
wherein the second coupling part is detachably coupled to the first coupling part to receive power, and on the rear surface of which a universal joint having a shaft connection part to be connected to a power transmission shaft of a working machine is integrally fixed.

11. The PTO coupling device according to claim 1, wherein the first coupling part and the second coupling part are locked together by locking means to prevent separation from each other.

12. The PTO coupling device according to claim 3, wherein the first coupling part is configured in such a way that a rear portion of the first coupling part is integrally formed on a PTO connection part for coupling with a PTO shaft to receive power, and
wherein the second coupling part is detachably coupled to the first coupling part to receive power, and on the rear surface of which a universal joint having a shaft connection part to be connected to a power transmission shaft of a working machine is integrally fixed.

13. The PTO coupling device according to claim 7, wherein the first coupling part is configured in such a way that a rear portion of the first coupling part is integrally formed on a PTO connection part for coupling with a PTO shaft to receive power, and
wherein the second coupling part is detachably coupled to the first coupling part to receive power, and on the rear surface of which a universal joint having a shaft connection part to be connected to a power transmission shaft of a working machine is integrally fixed.

14. The PTO coupling device according to claim 8, wherein the first coupling part is configured in such a way that a rear portion of the first coupling part is integrally formed on a PTO connection part for coupling with a PTO shaft to receive power, and
wherein the second coupling part is detachably coupled to the first coupling part to receive power, and on the rear surface of which a universal joint having a shaft connection part to be connected to a power transmission shaft of a working machine is integrally fixed.

15. The PTO coupling device according to claim 3, wherein the first coupling part and the second coupling part are locked together by locking means to prevent separation from each other.

16. The PTO coupling device according to claim 7, wherein the first coupling part and the second coupling part are locked together by locking means to prevent separation from each other.

17. The PTO coupling device according to claim 8, wherein the first coupling part and the second coupling part are locked together by locking means to prevent separation from each other.
